(19) United States
(12) Patent Application Publication
(10) Pub. No.: US 2015/0012831 A1
(43) Pub. Date: Jan. 8, 2015

(54) SYSTEMS AND METHODS FOR SHARING GRAPHICAL USER INTERFACES BETWEEN MULTIPLE COMPUTERS

(71) Applicant: Jason Boggess, Cambridge, MA (US)

(72) Inventor: Jason Boggess, Cambridge, MA (US)

(73) Assignee: JACOH, LLC, Cambridge, MA (US)

(21) Appl. No.: 14/324,999

(22) Filed: Jul. 7, 2014

Related U.S. Application Data
(60) Provisional application No. 61/843,661, filed on Jul. 8, 2013.

(51) Int. Cl. H04L 29/06

(52) U.S. Cl. CPC H04L 65/403
USPC 715/733

(57) ABSTRACT

An exemplary embodiment of the present invention provides GUI sharing method. The method comprises opening an application on a first CPU, the application creating a GUI on the display of the CPU, and providing access to the GUI to a user of a second CPU. In some embodiments of the present invention, providing access to the GUI to a user of the second CPU comprises dragging the GUI to an edge of a display of the first CPU. In some embodiments of the present invention, providing access to the GUI to a user of the second CPU results in the GUI being displayed on a display of the second CPU.

### CROSS REFERENCE TO RELATED APPLICATIONS

This application claims priority to U.S. Provisional Patent Application Ser. No. 61/843,661 filed Jul. 8, 2013 sharing the same title, which application is incorporated by reference as part of the instant application in its entirety.

### TECHNICAL FIELD OF THE INVENTION

The various embodiments of the present disclosure relate generally to computer communications. More particularly, the various embodiments of the present invention are directed to systems and methods for allowing a graphical user interface to be shared between separate computers.

### BACKGROUND OF THE INVENTION

The ability to provide a remote CPU user access to another person's computer or files thereon has become increasingly important over the past few years. For example it may be necessary for an IT technician to access the CPU of an employee to install programs or troubleshoot issues on that employee's CPU. To do so, the employee might allow the IT technician to access the employee's CPU remotely. Additionally, other conventional programs enable a CPU user to grant access to one or more other CPU users at other locations for those other users to view the desktop of CPU user. Each of these conventional programs, however, suffer major drawbacks regarding privacy. Specifically, in each case a user is unable to select a specific graphical user interfaces (“GUIs”), i.e., windows, specific applications, or portions thereof, for other remote individuals to access.

The following presents an overview of the state of the art prior to the advent of the invention disclosed herein.

1. Virtual Network Computing (VCN)

Virtual Network Computing (VNC) allows a user to have remote access to a physical computer or virtual machine while operating another computer system. There are many conventional VNC software packages available, such as TightVNC, LogMeIn, GoToMyPC, Windows Remote Desktop, etc.

While the specific technologies may differ at the lowest levels between products, the general functionality of these conventional VCN systems is the same: the screen of the host computer is captured by either using system-specific screen capture APIs (such as the .NET Graphics.CopyFromScreen method in Windows or Quartz in OS X on Mac) or by using a mirror display driver (the latter being faster, but more difficult to develop, as it has direct access to the graphical buffer as it is rendered). The captured desktop image is compressed (normally with jpeg or motion jpeg) and served through a computer network to client machine. The VNC host monitors changes in audio and video, and streams the media changes to the client as needed.

Simultaneously, when the mouse or keyboard is clicked or pressed respectively on the client machine inside the client VNC software, the input is captured and transmitted back to the host machine. The host machine then simulates the input made by the client again by using operating system specific APIs (such as SendKeys API in Windows or the Quartz CGEventPostToPSN on OS X for Mac).

These types of systems allow for inputs on the client machine to be executed on the host machine and outputs from the host machine rendered on the client, creating a complete remote control system. Accordingly, VNC computing may be useful for users managing several computers or virtual machines at once.

2. Conferencing (VNC Broadcasting)

One of the conventional technologies built around screen sharing is broadcasting one's desktop for the purpose of hosting a meeting or side-by-side collaboration. These systems (e.g., Skype, Microsoft Communicator (also Lynx, Live Meeting), Adobe Connect, GoToMeeting, DimDim, WebEx, TeamViwer, etc.) allow at most one user to be sharing content at a time that can then be broadcasted to several clients.

The implementation of these software packages is strikingly similar to that of VNC software. The host machine captures the display of its desktop and broadcasts to one or more client machines. Some systems allow only for specific windows or applications to be captured, which is done in a similar way as VNC by capturing the entire desktop and cropping out areas of interest. Specifically, this may be accomplished in conventional systems by finding windows for a given process ID and finding a window's location and size using system-specific APIs like those found in Window's User32 API.

Duplicating the data to transmit to multiple systems is also trivial, and can be done by replicating the media on a central server or using UDP to broadcast content to a local network.

Most of these systems allow at most one user to provide input to the to the host's machine, by asking for access from the host (or presenter). The input route is the same as VNC software, capturing events client-side and transmitting them to the host's computer to be simulated.

3. Computer as Secondary Display (VNC on Specific Screen Location)

Some conventional software packages employ another variation on VNC to allow a user to turn a secondary computer (such as a laptop or tablet) into an additional monitor for their primary computer. Examples of these systems include AirDisplay, ZoneOS, MaxiVista, ScreenRecycler, etc.

These types of systems operate by first emulating a secondary monitor on the primary computer by either installing a virtual display driver or by hooking the PCI bus to increase the number of displays the system recognizes. After the hook, the primary computer shows one more display attached than is physically present, with the new display having the same pixel resolution as the secondary computer. Since the operating system now sees the virtual desktop as extended, it will render over the entire area—visible and invisible areas on the primary machine—and not just over the physical hardware.

Custom VNC software is then designed to interact with only the virtual monitor and not the rest of the desktop, transmitting that data to the secondary computer. The secondary computer runs a full-screen VNC client application, completing the illusion that the primary computer has been extended onto the secondary computer as an extra monitor.

4. Remote Application

Some operating systems allow remote applications (e.g., Microsoft Windows Remote Application, and X11-window forwarding on most Linux-based systems).

In the case of X11-window forwarding, the application is rendered on the client machine, instead of on the host machine. This differs greatly from VNC as window components, such as text boxes, menus, etc.—instead of the visual information—have to be transferred to the client. In this type of system, the final rendering on the client may differ from client-to-client based on the rendering software and version used. This also allows for customization from the client computer.

5. Drawbacks of Conventional Systems

Existing systems and techniques, such as the systems and techniques discussed above, suffer from a number of drawbacks. For example, VNC systems with remote control do allow two users to edit or control a document almost simultaneously. However, because these types of systems rely on screen capture techniques, the host computer must constantly be displaying the application on its desktop in order to share or allow others to take control. If the user at the host computer is sharing a word-processing being edited by the client, for instance, as soon as the host switches to work on a presentation, the client loses access to the word-processing document. Both the host and the client must be working on the same document at the same time in VNC systems.

Conventional VNC systems also have issues with multiple screen resolutions. If the host has a very high screen resolution and the client a small one, applications will be scaled down, and become difficult to view. Client viewers are designed to zoom and scroll, but this provides a less-than-optimum user experience.

Applications such as Google Docs and Microsoft Office 365 allow multiple users to work on the same document at the same time without needing screen real estate to do so. For example, a user of these types of applications may switch between Google Docs running in a browser and other applications running on a desktop. However, Google Docs and Microsoft Office 365 only allow collaboration on their own branded software, and are not cross-compatible with other office systems.

Remote application systems require the host and client machine to run the same operating system (or have a client-side rendering engine). This means that client applications may appear differently on different computers, leading to an inconsistent user experience.

Therefore, there is a desire for systems and methods aimed at alleviating one or more of the drawbacks associated with conventional systems. Various embodiments of the present invention address these desires.

### BRIEF SUMMARY OF THE INVENTION

The present invention relates to computer file/applications sharing systems and methods. An exemplary embodiment of the present invention provides a GUI sharing method. The method comprises opening an application on a first CPU, the application creating a GUI on the display of the CPU, and providing access to the GUI to a user of a second CPU. In some embodiments of the present invention, providing access to the GUI to a user of the second CPU comprises dragging the GUI to an edge of a display of the first CPU. In some embodiments of the present invention, providing access to the GUI to a user of the second CPU results in the GUI being displayed on a display of the second CPU.

In another exemplary embodiment, a method for sharing one or more GUIs between a plurality of computer systems is provided. In this exemplary embodiment, the method may include obtaining, by a first computer system, display data representing at least a portion of a GUI associated with an application executing on the first computer system. The method may also include transmitting, by the first computer system, the display data to a second computer system. The method may further include obtaining, by the first computer system from the second computer system, input data describing one or more user inputs into the second computer system associated with the display data. Additionally, the method may include generating, by the first computer system, simulated input data based on the input data. The simulated input data may mimic the one or more user inputs into the second computer system. Finally, in this exemplary embodiment, the method may include providing, by the first computer system, the simulated input data to the application executing on the first computer system. In this example, providing the simulated input data to the application may cause the application to adjust the display data representing at least a portion of the GUI associated with the application in order to provide adjusted display data.

In yet another exemplary embodiment, the foregoing method may include (i) obtaining, by the first computer system, the adjusted display data and (ii) transmitting, by the first computer system, the adjusted display data to the second computer system. In another example, the method may also include (i) obtaining, by the first computer system from the second computer system, different input data describing one or more different user inputs into the second computer system associated with the adjusted display data; (ii) generating, by the first computer system, different simulated input data based on the different input data, wherein the different simulated input data mimics the one or more different user inputs into the second computer system; and (iii) providing, by the first computer system, the different simulated input data to the application executing on the first computer system, wherein providing the different simulated input data to the application causes the application to further adjust the adjusted display data representing at least a portion of the GUI associated with the application in order to provide further adjusted display data.

In another exemplary embodiment, the method may include obtaining, by the first computer system, share instruction data. The share instruction data may include an instruction to share, with the second computer system, at least a portion of the GUI associated with the application being executed on the first computer system. In one example, obtaining the share instruction data may include obtaining an indication that a user of the first computer system has dragged at least a portion of the GUI off of an edge of a display device of the first computer system.

In still another exemplary embodiment, the method may include rendering, by the first computer system, the display data prior to transmitting the display data to the second computer system. In another embodiment, the method may include rendering, by the second computer system, the display data after the display data has been transmitted from the first computer system to the second computer system.

Related computer systems and non-transitory computer-readable media are also encompassed within the teachings of the instant disclosure.

These and other aspects of the present invention are described in the Detailed Description of the Invention below and the accompanying figures. Other aspects and features of embodiments of the present invention will become apparent to those of ordinary skill in the art upon reviewing the following description of specific, exemplary embodiments of the present invention in concert with the figures. While features of the present invention may be discussed relative to certain embodiments and figures, all embodiments of the present invention can include one or more of the features discussed herein. Further, while one or more embodiments may be discussed as having certain advantageous features, one or more of such features may also be used with the various embodiments of the invention discussed herein. In similar fashion, while exemplary embodiments may be discussed below as device, system, or method embodiments, it is to be understood that such exemplary embodiments can be implemented in various devices, systems, and methods of the present invention.

### BRIEF DESCRIPTION OF THE DRAWINGS

The following Detailed Description of the Invention is better understood when read in conjunction with the appended drawings. For the purposes of illustration, there is shown in the drawings exemplary embodiments, but the subject matter is not limited to the specific elements and instrumentalities disclosed.

FIG. 1 illustrates how a GUI can be shared from a first CPU to a second CPU, in accordance with an exemplary embodiment of the present invention.

FIG. 2 illustrates how a GUI on a first CPU can be shared to multiple other CPUs simultaneously, in accordance with an exemplary embodiment of the present invention.

FIG. 3 illustrates bidirectional sharing of GUIs between first and second CPUs, in accordance with an exemplary embodiment of the present invention.

FIG. 4 illustrates examples of how multiple users can simultaneously share GUIs with multiple other users, in accordance with an exemplary embodiment of the present invention.

FIG. 5 illustrates the sharing of files between first and second CPUs, in accordance with an exemplary embodiment of the present invention.

FIG. 6 is a block diagram illustrating a computer system for sharing one or more graphical user interfaces (GUIs) between a plurality of computer systems, in accordance with one or more exemplary embodiments of the present invention.

FIG. 7 is a block diagram illustrating a networked system for sharing one or more graphical user interfaces (GUIs) between a plurality of computer systems, in accordance with one or more exemplary embodiments of the present invention.

FIG. 8 is a flowchart illustrating a method for sharing one or more graphical user interfaces (GUIs) between a plurality of computer systems, in accordance with an exemplary embodiment of the present invention.

FIG. 9 is a block diagram illustrating another networked system for sharing one or more graphical user interfaces (GUIs) between a plurality of computer systems, in accordance with one or more exemplary embodiments of the present invention.

FIG. 10 is a block diagram illustrating a system for sharing a plurality of graphical user interfaces from a plurality of different operating systems in accordance with one or more exemplary embodiments of the present invention.

### DETAILED DESCRIPTION OF THE INVENTION

To facilitate an understanding of the principles and features of the present invention, various illustrative embodiments are explained below. To simplify and clarify explanation, the invention is described below as applied to systems and methods for sharing applications or GUIs between a first CPU and a second CPU.

The components, steps, and materials described hereinafter as making up various elements of the invention are intended to be illustrative and not restrictive. Many suitable components, steps, and materials that would perform the same or similar functions as the components, steps, and materials described herein are intended to be embraced within the scope of the invention. Such other components, steps, and materials not described herein can include, but are not limited to, similar components or steps that are developed after development of the invention.

The present invention provides systems and methods for allowing a user at a first CPU to share one or more applications or GUIs displayed on the desktop of the first CPU with a user at a second CPU. For example, the user of the first CPU can open an application, such a calculator, which displays as a GUI on the display of the first CPU. The user can then provide a user at a second CPU with access to the GUI by, for example, dragging the GUI to the edge of the screen. When the GUI is drug to the edge of the screen—and off of the screen, the GUI can appear on the display of the second CPU. The user of the second CPU could then interface with the calculator GUI. Once the user of the second CPU is finished interfacing with the calculator GUI, the user of the second CPU could then return the GUI to the display of the first CPU, where the user of the first CPU could continue interfacing with the GUI.

Various embodiments of the present invention allow a user to share one or more applications and/or GUIs with a user of a second CPU. For example, as discussed above, a user can choose to share a single GUI with a user of a second CPU. In another exemplary embodiment, a user can choose multiple GUIs to share with a user of a second CPU. In yet another exemplary embodiment of the present invention, a user can choose to share all GUIs associated with a specific application, e.g., Microsoft Word, with a user of a second CPU. Thus, various embodiments of the present invention, allow a user to pick and choose only selected applications and/or GUIs to share with a user of the second CPU without providing the user of the second CPU complete access to all applications and/or GUIs on the first CPU.

Unless context clearly dictates otherwise, as used herein, the ability of the present invention to share a GUI should also be read to apply to applications and files. Thus, by describing an embodiment of the present invention where a GUI can be shared, those skilled in the art should also appreciate a similar embodiment of the present invention allows an application or file to be shared.

The user of a first CPU can share a GUI with a user of a second CPU a number of different ways in accordance with various embodiments of the present invention. In an exemplary embodiment of the present invention, a user of the first CPU can share a GUI with a user of the second CPU by selecting choosing a share option on the GUI. In some embodiments, the share option can be chosen via a drop down menu. In some embodiments of the present invention, the share option can be chosen via user input button on the GUI. In another exemplary embodiment of the present invention, a user of the first CPU can share a GUI with a user of the second CPU by dragging the GUI to and off an edge of a display of the first CPU. In some embodiments of the present invention, a threshold percentage of the GUI on a user's CPU is used to determine whether the GUI is shared. For example, if the user of the first CPU drags more than 50% of the GUI off of the display of the first CPU, the GUI is then shared to the user of the second CPU.

When a user of a first CPU shares a GUI with a user of the second CPU, the GUI can appear on a display of the second CPU. In some embodiments of the present invention, the GUI can simultaneously appear on the displays of both the first and second CPUs. In some embodiments of the present invention, the GUI only appears on a single display at a time; thus, when the GUI is shared with the user of the second CPU, the GUI is no longer displayed on the display of the first CPU—only the second CPU. In some embodiments of the present invention, when the GUI is shared with the user of the second CPU the second CPU can provide an indication that the particular GUI is a shared GUI from a first CPU. The indication can be performed via many different indicators. In an exemplary embodiment of the present invention, the indication can be a colored border displayed around the GUI when the GUI is displayed on the display of the second CPU. In another exemplary embodiment of the present invention, the indication can be a text box displayed on the GUI when the GUI is displayed on the display of the second CPU.

In some embodiments of the present invention, the GUI can be shared in a read/view only format. Thus, the user of the second CPU may be able to see the GUI on the display of the second CPU, but the user of the second CPU cannot input to the GUI. In some embodiments of the present invention, the GUI can be shared in a read/view and write format. Thus, the GUI may be shared to the user of the second CPU, such that the user of the second CPU can input/manipulate the GUI before returning the GUI to the user of the first CPU. When the GUI is returned to the user of the first CPU, the user of the first CPU can see the changes made by the user of the second CPU. In some embodiments, the users of the first and second CPUs can see changes made by the other CPU in real time.

In some embodiments of the present invention, the user of the first CPU retains authority to retract the shared GUI at anytime. For example, the user of the first CPU can select an option at any time to return a shared GUI to the first CPU. In some embodiments of the present invention, the user of the second CPU has authority over the GUI until the user of the second CPU chooses to return the GUI to the first CPU.

Some embodiments of the present invention provide a chat feature allowing a user of the first CPU and a user of the second CPU to communicate with each other. For example, a user of the first CPU can type text into a text box to communicate with the user of the second CPU before or while a GUI is shared with the user of the second CPU. The text entered by the user of the first CPU is displayed to the user of the second CPU. The user of the second CPU can similarly enter text to be displayed to the user of the first CPU.

Some embodiments of the present invention provide temporary storage of files to the user of the second CPU. For example, a user of the first CPU may choose to share a picture with a user of the second CPU on a temporary basis. The user of the first CPU may open the picture file on the first CPU and share the opened file with the user of the second CPU in accordance with the aspects of the invention discussed above. Once the file is shared with the user of the second CPU, a temporary storage file may be created on the second CPU. The temporary storage file can be deleted after a predetermined time. In some embodiments of the present invention, the predetermined time is the time is until the sharing session between the users is terminated. In some embodiments of the present invention, a security feature is added to the file in the temporary storage to prevent copies of the file from being created and permanently stored on the second CPU.

Some embodiments of the present invention allow bidirectional sharing of GUIs between two or more users. For example, a first user on a first CPU can share one or more GUIs with a second user on a second CPU while the second user on the second CPU simultaneously shares one or more GUIs with the first user on the first CPU. In some embodiments of the present invention, the first and second users can provide inputs and manipulate the shared GUIs simultaneously.

The various embodiments of the present invention are not limited to sharing between only two users at a given time. Instead, some embodiments of the present invention allow a user to share GUIs with multiple users, simultaneously. For example, some embodiments of the present invention allow a first user at a first CPU to share one or more GUIs with a second user at a second CPU and share one or more GUIs with a third user at a third CPU, simultaneously.

Some embodiments of the present invention also allow a first user on a first CPU to share certain sounds with a user of a second CPU. For example, a first user on a first CPU can play an MP3 on the first CPU and choose to share the audio generated by the MP3 player on the first CPU with a user on the second CPU. The user on the second CPU can then hear the audio generated by the MP3 player on the first CPU via the second CPU.

In some embodiments of the present invention, when a GUI from a first CPU is shared with the second CPU, only the visual graphics are shared to the second CPU, while processes for running the GUI are continued to run off of the first CPU. For example, a calculator GUI from a first CPU can be shared to the second CPU. The first CPU can communicate graphical display data to the second CPU so that the second CPU can properly display the calculator on a display of the second CPU. The program running the calculator, however, continues to operate on the first CPU. If the user of the second CPU desires to input to or manipulate the GUI on the second CPU, embodiments of the present invention can intercept inputs from the second CPU, e.g., mouse or keyboard inputs, transfer those inputs to the first CPU where the first CPU can process those inputs with the application running the GUI. The first CPU can then process which graphic display should change on the GUI in view of the inputs from the second CPU and send that display data to the second CPU so that the display of the GUI on the second CPU is updated in view of the inputs.

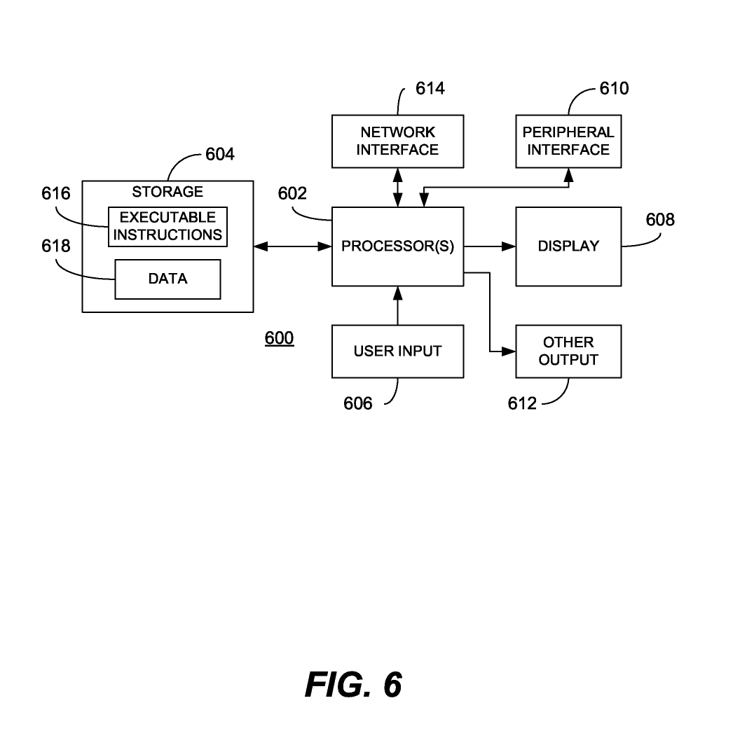

FIG. 6 is a block diagram illustrating one example of a computer system 600 suitable for use in sharing one or more graphical user interfaces (GUIs) between a plurality of computer systems. The computer system 600 may be, for example, a server computer (e.g., a database and/or application server), a laptop of desktop computer, a cellular phone, a “smart” phone, a personal digital assistant (PDA), a tablet, or any other suitable computer system capable of performing the processing described herein. In addition, although illustrated as a stand-alone computer system 600, those having ordinary skill will appreciate that the components of computer system 600 may physically exist remotely from one another, but still maintain communication with one another over one or more suitable networks.

In the illustrated example, the computer system 600 includes one or more processors 602 coupled to a storage component 604. The storage component 604, in turn, comprises stored executable instructions 616 and data 618. In an embodiment, the processor(s) 602 may include one or more of a microprocessor, microcontroller, digital signal processor, co-processor or the like or combinations thereof capable of executing the stored instructions 616 and operating upon the stored data 618. Likewise, the storage component 604 may include one or more devices such as volatile or nonvolatile memory including but not limited to random access memory (RAM) or read only memory (ROM). Further still, the storage component 604 may be embodied in a variety of forms, such as a hard drive, optical disc drive, floppy disc drive, solid-state memory, etc. Processor and storage arrangements of the types illustrated in FIG. 6 are well known to those having ordinary skill in the art. In one embodiment, the processing techniques described herein are implemented as a combination of executable instructions and data within the storage component 604.

As shown, the computer system 600 may include one or more user input devices 606, a display 608, a peripheral interface 610, other output devices 612 and a network interface 614 in communication with the processor(s) 602. The user input device 606 may include any mechanism for providing user input to the processor(s) 602. For example, the user input device 606 may include a keyboard, a mouse, a touch screen, microphone and suitable voice recognition application, or any other means whereby a user of the computer system 600 may provide input data to the processor(s) 602. The display 608 may include any conventional display mechanism such as a cathode ray tube (CRT), flat panel display, or any other display mechanism known to those having ordinary skill in the art. In an embodiment, the display 608, in conjunction with suitable stored instructions 616, may be used to implement a graphical user interface (GUI). The peripheral interface 610 may include the hardware, firmware and/or software necessary for communication with various peripheral devices, such as media drives (e.g., magnetic disk or optical disk drives), other processing devices (e.g., other computer systems with whom one or more portions of one or more GUIs are to be shared) or any other input source (e.g., user computers) used in connection with the instant techniques.

Likewise, the other output device(s) 612 may optionally include similar media drive mechanisms, other processing devices or other output destinations capable of providing information to a user of the computer system 600, such as speakers, LEDs, tactile outputs, etc. Finally, the network interface 614 may include hardware, firmware and/or software that allows the processor(s) 602 to communicate with other devices via wired or wireless networks, whether local or wide area, private or public, as known in the art. For example, such networks may include the World Wide Web or Internet, or private enterprise networks, as known in the art.

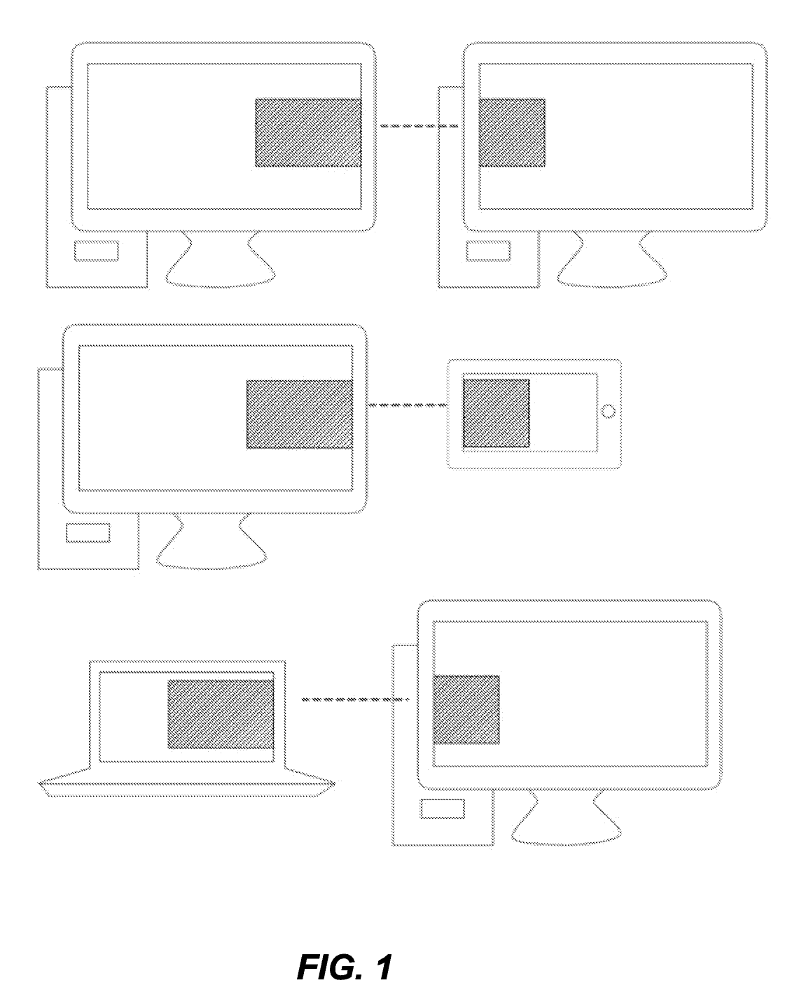

While the computer system 600 has been described as one form for implementing the techniques described herein, those having ordinary skill in the art will appreciate that other, functionally equivalent techniques may be employed. For example, as known in the art, some or all of the functionality implemented via executable instructions may also be implemented using firmware and/or hardware devices such as application specific integrated circuits (ASICs), programmable logic arrays, state machines, etc. Furthermore, other implementations of the computer system 600 may include a greater or lesser number of components than those illustrated. Once again, those of ordinary skill in the art will appreciate the wide number of variations that may be used is this manner. And again, although a single processing computer system 600 is illustrated in FIG. 1, it is understood that a combination of such processing devices may be configured to operate in conjunction (for example, using known networking techniques) to implement the teachings of the instant disclosure.

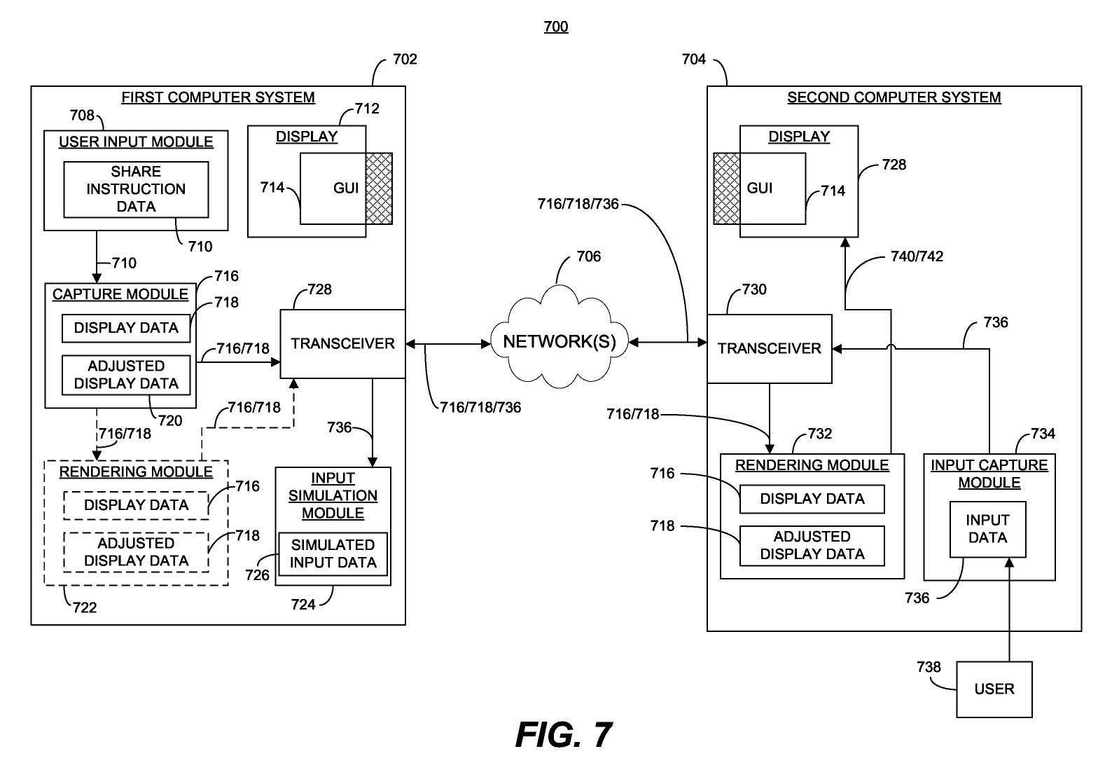

FIG. 7 is a block diagram illustrating a networked system 700 for sharing one or more graphical user interfaces (GUIs) between a plurality of computer systems (e.g., computer systems 702, 704) in accordance with one or more exemplary embodiments of the present invention. As shown, the networked system 700 includes a first computer system 702 in networked connection (e.g., via one or more suitable wired or wireless network(s) 706) with a second computer system 704. Either, or both, of the computer systems 702, 704 may be implemented in accordance with the foregoing teachings concerning computer system 600 shown in FIG. 6.

The first computer system 702 may include a user input module 708, a display 712 (e.g., a display device such as a CRT monitor or other suitable display devices known in the art), a capture module 716, an input simulation module 724, and a transceiver 728. In some embodiments (discussed below), the first computer system 702 may also include a rendering module 722.

The second computer system 704 may include a display 728 (e.g., a display device such as a CRT monitor or other suitable display devices known in the art), a transceiver 730, and an input capture module 734. In some embodiments (discussed below), the second computer system may include another rendering module 732. As will be apparent from the following discussion, in practice, both the first computer system 702 and the second computer system 704 may include some or all of the same modules (e.g., user input modules, capture modules, rendering modules, input simulation modules, an input capture modules) allowing for the bi-directional sharing of one or more GUIs. However, for purposes of simplicity, FIG. 7 is shown from the perspective of the first computer system 702 sharing at least a portion of a GUI 714 with the second computer system 704. Stated differently, all of the functionality attributed to the first computer system 702 could suitably be provided by the second computer system 704 as well without deviating from the scope of the instant disclosure.

In operation, the networked system 700 may function as follows. The capture module 716 of the first computer system 702 may obtain display data 718 representing at least a portion of a GUI (e.g., at least a portion of GUI 714) associated with an application executing on the first computer system 712. As used herein, “obtain” may include receiving, fetching, and/or copying. Further, as used herein, the display data 718 may include pixel data representing at least a portion of a GUI associated with an application executing on the first computer system 702. The display data 718 may take a wide variety of formats known in the art (e.g., RGB, ARGB, YCbCr, etc.), and the teachings of the instant disclosure apply regardless of the precise format of the display data 718.

The manner in which the display data 718 may be obtained may also vary, for example, based upon the operating system (OS) running on the first computer system 702. For example, in an embodiment where the OS running on the first computer system 702 is Microsoft Windows, the capture module 716 may obtain the display data 718 by copying the display data 718 from memory. In another embodiment where the OS running on the first computer system 702 is Microsoft Windows or another type of OS, the capture module 716 may obtain the display data 718 by copying the display data from the kernel space associated with the OS. In still another embodiment where the OS running on the first computer system 702 is a Mac OS, the capture module 716 may obtain the display data by interfacing with an application programming interface (API), such as the API built into the Quartz rendering engine in OS X.

As noted above, the display data 716 represents at least a portion of a GUI (e.g., at least a portion of GUI 714) associated with an application executing on the first computer system 702. Thus, by way of example and not limitation, the first computer system 702 may be executing an application such as the calculator application discussed above. The capture module 716 may obtain display data 718 associated with at least a portion of the GUI associated with the calculator application. Of course, in some embodiments, the display data 718 may be associated with the entire GUI associated with the calculator application. However, one aim of the instant disclosure to is provide for the selective sharing of only portions of one or more GUIs associated with one or more applications.

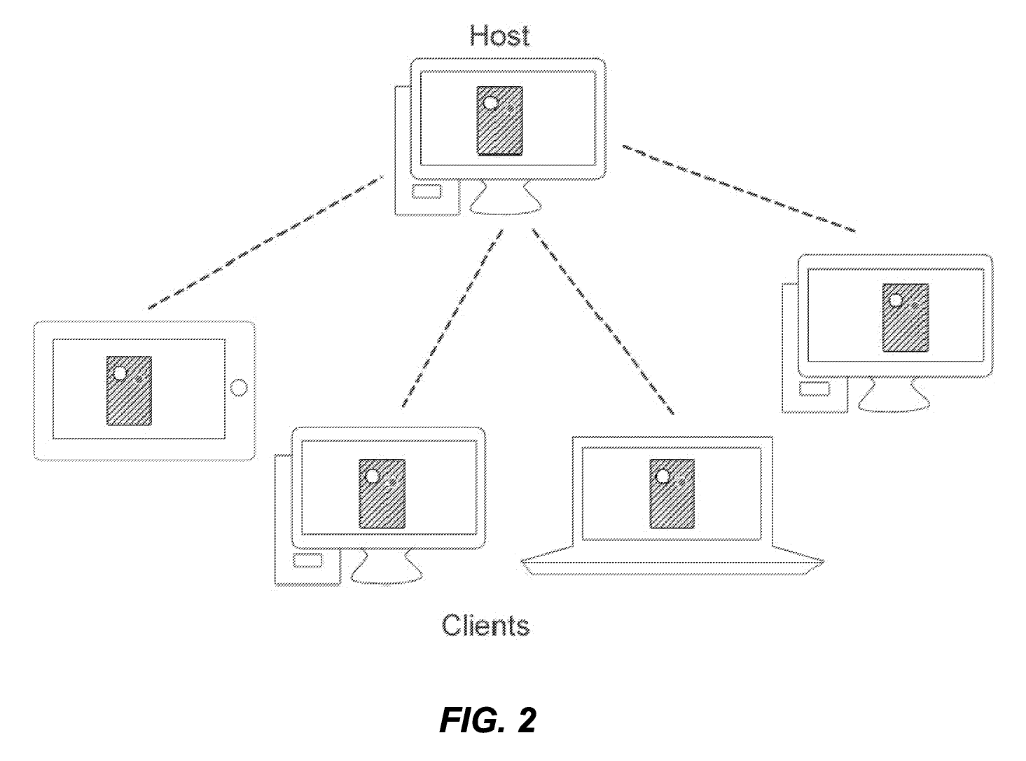

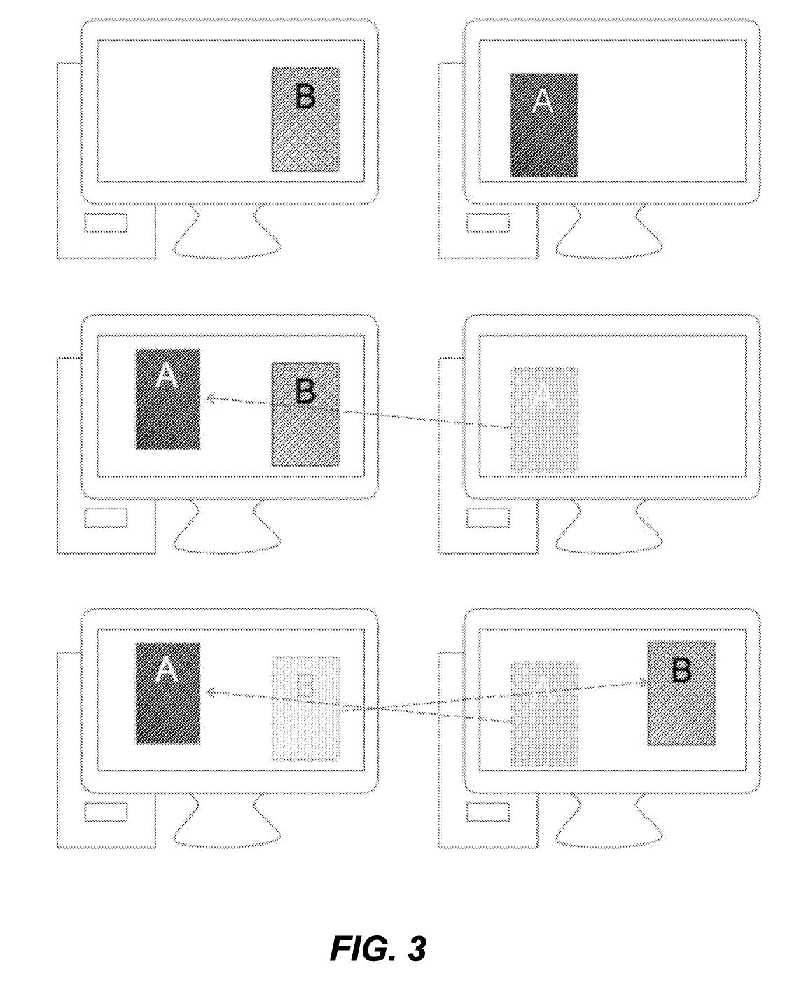

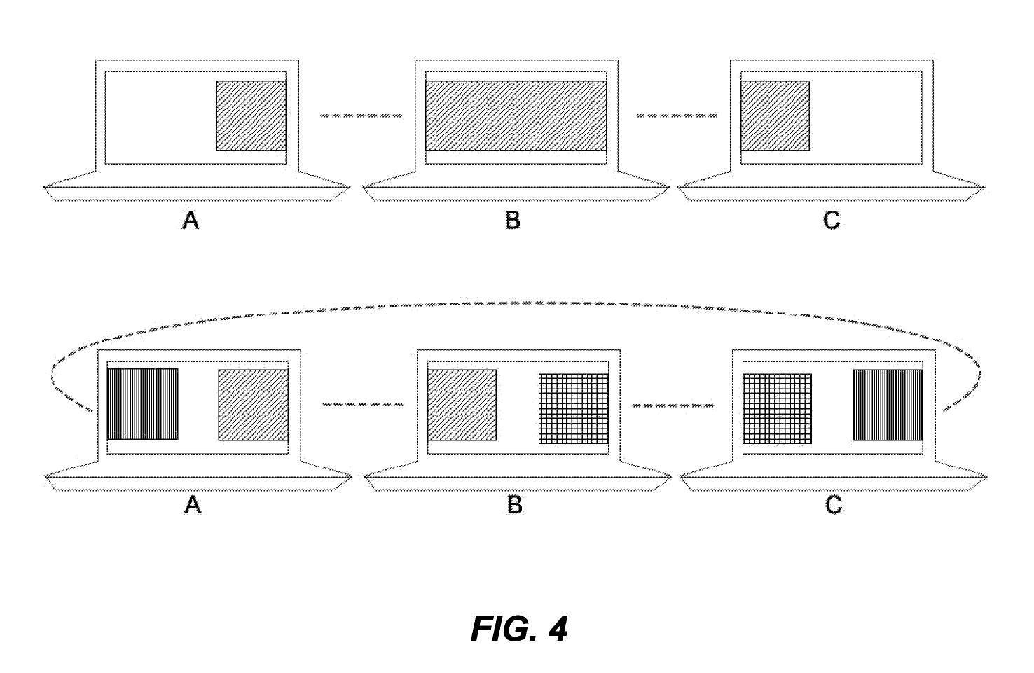

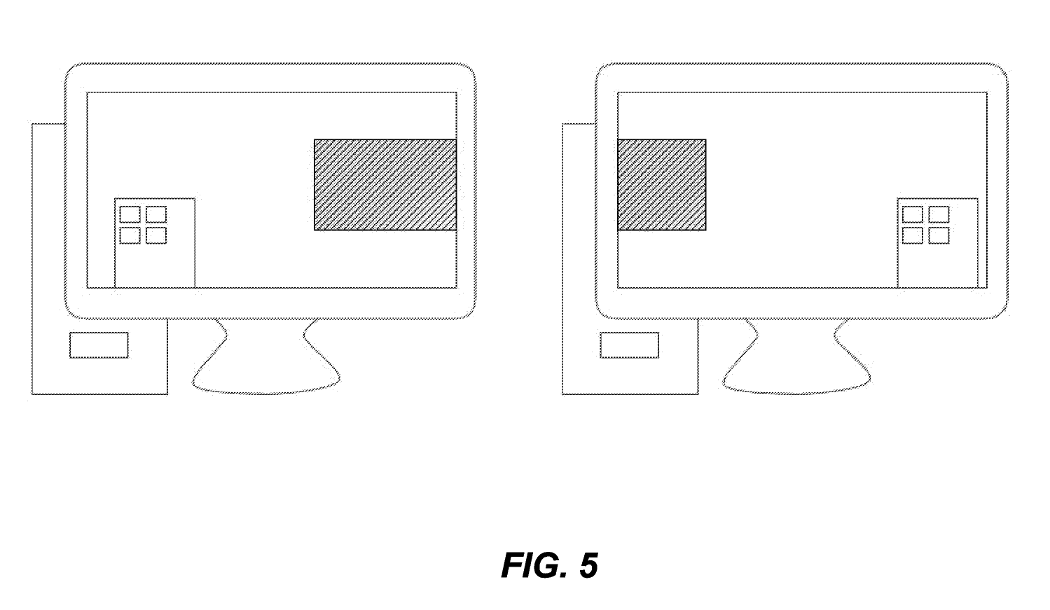

Turning briefly to the user input module 708, this module 708 may be used to instigate the GUI sharing operations disclosed herein. Specifically, the user input module 708 may be configured to obtain share instruction data 710 from a user of the first computer system 702. The share instruction data 710 may include data comprising an instruction to share, with the second computer system 704, at least a portion of the GUI 714 associated with the application executing on the first computer system 702. The share instruction data 710 may be supplied by the user of the first computer system in a variety of manners, many of which are described above with reference to FIGS. 1-5 herein. For example, in one embodiment, a user of the first computer system 702 may supply the share instruction data 710 by selecting a share option (e.g., using a mouse) from the GUI 714 associated with the application executing on the first computer system. In another embodiment, a user of the first computer system 702 may supply the share instruction data 710 by selecting a share option from a drop down menu accessible via the GUI 714 associated with the application executing on the first computer system.

In one embodiment, a user of the first computer system 702 may supply the share instruction data 710 by dragging the GUI 714 (or a portion of the GUI 714) off of an edge of the display device 712 of the first computer system 702. In one example of this embodiment, any portion of the GUI 714 that has been dragged off of the edge of the display device 712 (including the entire GUI, in some embodiments) will no longer be visible via the display device 712 to the user of the first computer system 702. In this manner, in some embodiments, a user 738 of the second computer system 704 (with whom the GUI 714 has been shared) may interact with the GUI (or the shared portion of the GUI) without the user of the first computer system seeing how the user 738 of the second computer system 704 is interacting with the shared GUI (or the shared portion of the GUI).

Continuing, the transceiver 728, which is operatively connected to the capture module 716, may obtain the display data 718 from the capture module 716. As used herein, “operatively connected” may include communicative coupling directly, or through one or more intermediate components, using wired or wireless communication protocols and related hardware known in the art. The transceiver 728 is configured to transmit the display data 718 to the second computer system 704 over one or more wired or wireless networks using network transmission protocols known in the art.

In one exemplary embodiment, the display data 718 may be passed from the capture module 716 to a rendering module 722 for rendering prior to transmission. The rendering module 722 may include software and/or hardware configured to render, compress, and/or decompress the display data 718 for output on a display device and/or transmission over network(s) 706. In one example, the rendering module 722 of the first computer system 702 and/or the rendering module 732 of the second computer system 704 may include programs such as Windows Media Player, Quicktime, or any other suitable program capable of performing rendering and/or data compression/decompression.

The transceiver 730 of the second computer system 704 may thus obtain the display data 718 from the transceiver 728 of the first computer system 702. In an embodiment where the display data 716 has not been rendered prior to transmission to the second computer system 704, the display data 718 may be passed from the transceiver 730 of the second computer system to a rendering module 730 for rendering locally on the second computer system 704. The rendered display data 740 may then be output for display on the display device 728 of the second computer system 704. At this point, a user of the second computer system 704 will be able to see the portion (or entirety, as the case may be) of the GUI associated with the application executing on the first computer system 702 via the display device 728.

A user 738 of the second computer system 704 may interact with the GUI 714 (or portion of the GUI) being displayed on the display device 728 of the second computer system 704 indirectly through use of the input capture module 734. The input capture module 734 may be configured to obtain input data 736 from the user 738. The input data 736 may include data describing one or more user inputs into the second computer system 704 associated with the rendered display data 740 (i.e., user inputs aimed at affecting or interacting with the GUI 714 or portion of the GUI being displayed on the display device 728). By way of example and not limitation, the input data 736 may include data describing keystrokes, mouse clicks, touches (e.g., in an embodiment where the display device 728 is a touch screen), voice commands, or any other suitable user interactions with the second computer system 704, as will be appreciated by those having ordinary skill in the art.

After the input capture module 734 of the second computer system 704 has obtained the input data 736, the input data 736 may be transmitted back to the first computer system 702 via the transceivers 730, 728 and the network(s) 706. The input simulation module 726 of the first computer system 702 is configured to obtain the input data 736 (e.g., from the transceiver 728) and generate simulated input data 726 based on the input data 736 obtained from the second computer device 704.

The simulated input data 726 may include data that mimics the one or more user inputs into the second computer system 704 as represented by the input data 736. Stated differently, the simulated input data 726 may be formatted by the input simulation module 724 such that the application executing on the first computer system 702 believes that the inputs from user 738 represented by the input data 736 were made locally on the first computer system 702. Accordingly, the input simulation module 724 may further be configured to provide the simulated input data 726 to the application executing on the first computer system 702. Providing the simulated input data 726 to the application executing on the first computer system 702 may cause the application to adjust the display data 716 representing at least a portion of the GUI 714 associated with the application in order to provide adjusted display data 718.

In another embodiment, providing the simulated input data 726 to the application executing on the first computer system 702 may cause the application to perform an operation other than adjusting the display data 716. For example, in some embodiments, user 738 may supply input data 736 aimed at affecting the application executing on the first computer system 702, but the input data 736 is not aimed at altering the GUI 714 in any way. For example, the input data 736 could represent the combined keystroke “ctrl+s” aimed at saving the state of the application executing on the first computer system 702, without altering the GUI 714 associated with the application executing on the first computer system 702.

Using the example discussed above where the application executing on the first computer system 702 is a calculator, a GUI representing the calculator may be shared with the second computer system 704 in line with the foregoing teachings. The user 738 of the second computer system 704 may then make various inputs into the second computer system 704 aimed at interacting with the calculator application. For example, the user 738 could plug “2+2” (e.g., via keystrokes and mouse clicks) into the second computer system 704, with the goal of the calculator application being executed on the first computer system 702 performing the calculation and updating the calculator GUI being displayed on the display device 728 of the second computer 704 to reflect the sum (i.e., “4”).

The initial instance of the calculator GUI presented to the user 738 via the display 728 may thus be based on the display data 716 (i.e., the instance of the calculator GUI before the user 738 supplied any input data 736 aimed at interacting with the calculator GUI). Then, after the user 738 supplies input data 736, that input data 736 may be used by the input simulation module 724 of the first computer system 702 to: (i) generate simulated input data 726 and (ii) provide the simulated input data 726 to the application (e.g., provide the simulated “2+2” input data), such that the application performs the calculation requested by the user 738. Following the calculation, the calculator GUI may be represented by the adjusted display data 718, such that the GUI now includes the sum of the calculation (i.e., “4”). The adjusted display data 718 may then be transmitted (e.g., via transceivers 728, 730 and network(s) 706) back to the second computer system 704 to update the GUI 714 being displayed on the display device 728 of the second computer 704 so that the user 738 can see the sum of the calculation on the updated GUI (i.e., “4”). As with the display data 716, the adjusted display data 718 may be rendered on the first computer system 702 prior to transmission to the second computer system (e.g., via rendering module 722) or rendered on the second computer system 704 (e.g., via rendering module 732, which in turn provides rendered adjusted display data 742 to the display device 728 for presentation to the user 738).

In some embodiments, the simulated input data 726 is generated by the input simulation module 724 through the use of system-specific APIs provided by the operating system. For example, if the input to be simulated is the three keystrokes “a b c”, the input may be sent to the active application in Windows using the SendKeys API. In another example, the simulated input could be a mouse motion, which could be sent to the desktop in Windows using the SendInput API.

In other embodiments, input can be simulated by injecting input messages into the system-messaging queue directed at a specific application. For instance, in the Windows operating system, the SendMessage/PostMessage API can be used to send input to a specific window handle or application using a WM_* message. For example, if the input to be simulated was the keystroke “a” to Chrome, the WM_KEYDOWN message could be sent to the window handle for the application Chrome, followed by the WM_KEYUP message, to simulate a keypress. Similarly, in the Mac OSX operating system, Quartz event services allow applications to inject simulated input by using functions such as CGPostKeyboardEvent or CGEventCreateKeyboardEvent to specific processes.

In further embodiments, input can be simulated by mimicking calls to system API functions designed to provide the current input state. For example, to simulate a mouse down state (when one of the mouse input buttons has been pressed down and held) the simulation must reflect a mouse down state for a period of time even though the physical mouse is not held down. This can be done by extending the system-level APIs that check input states. For instance, the GetKeyState method in the Windows operating system can be extended when querying for the mouse state to return “down” for applications undergoing simulation and “up” for applications not undergoing simulation. When a simulated application calls the GetKeyState function during that period, the result will be “down”, while a non-simulated application will have the result state be “up.” The applications that are undergoing simulation can be maintained as a list. In one embodiment of the invention, the specific application that called the method can be obtained by looking at the process id. In other embodiments of the invention, the calling application can be determined by traversing the call stack.

In some embodiments of the invention, the simulated GUI may undergo input from two users simultaneously—either by two users interacting with the second computer system 704 (e.g., user 738 and an additional user) or by a user of the first computer system 702 and user 738. In this case, input can be interweaved together by simulating input from one system followed by simulating input from another system, etc. In one example, input can be blocked on the first computer system 702 by hooking and consuming the input messages on the system queue for that given GUI. This prevents input from two systems to be provided at the exact same time. In another example, input on the first computer system 702 can be replayed using one of the methods described above after it has been blocked from the queue to appear that two users are using the same GUI simultaneously.

In another embodiment, an input system comprised of one or more of the above techniques may be used to adequately simulate input. In another embodiment, all system input is blocked and sent through the input simulation module 724, as opposed to going directly to applications.

In some embodiments, and as noted above, the computer systems 702, 704 of FIG. 7 may both include all of the necessary components in to facilitate the bi-directional sharing of GUIs. In addition, in some embodiments, a user of the second computer system 704 may share at least a portion of a GUI associated with an application executing on the second computer system 704 while the user of the first computer system 702 simultaneously shares at least a portion of a GUI associated with an application executing on the first computer system 702 with the second computer system 704.

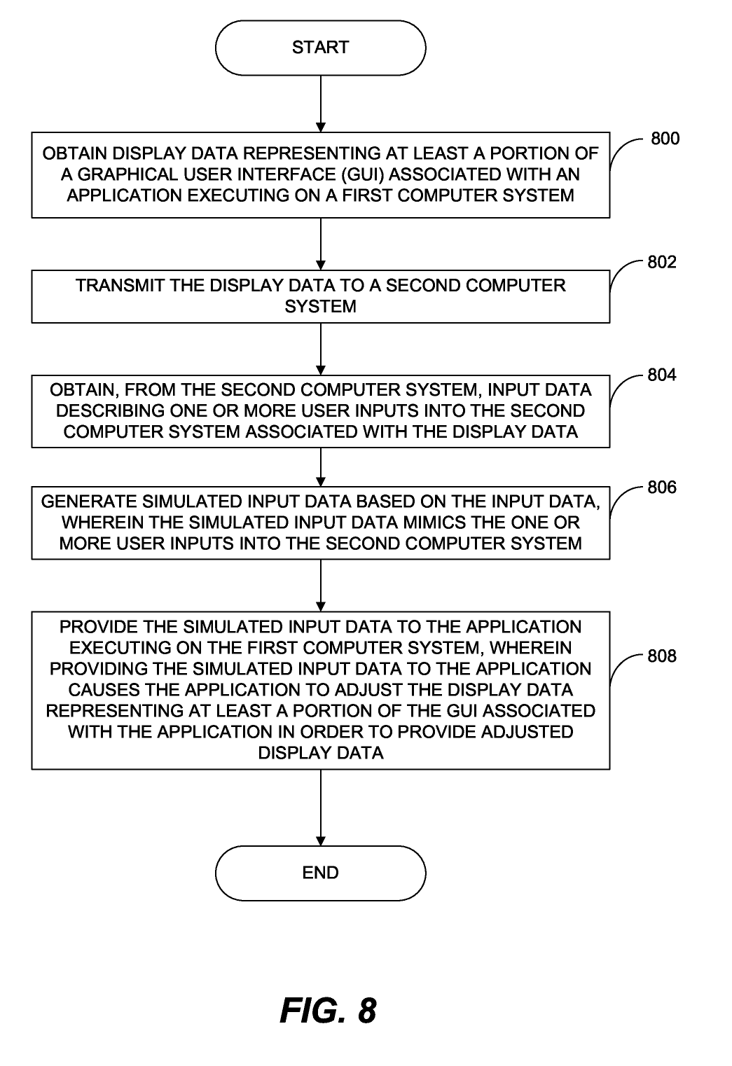

Referring now to FIG. 8, a flowchart illustrating a method for sharing at least a portion of one or more graphical user interfaces (GUIs) between a plurality of computer systems is provided in accordance with an exemplary embodiment of the present invention. While the computer system 600 is one form for implementing the processing described herein (including that illustrated in FIG. 8), those having ordinary skill in the art will appreciate that other, functionally equivalent techniques may be employed. Furthermore, as known in the art, some or all of the functionalities implemented via executable instructions may also be implemented using firmware and/or hardware devices such as supplication specific circuits (ASICs), programmable logic arrays, state machines, etc. Once again, those of ordinary skill in the art will appreciate the wide number of variations that may be used in this manner.

Beginning at step 800, display data representing at least a portion of a GUI associated with an application executing on a first computer system may be obtained. At step 802, the display data may be transmitted to a second computer system. At step 804, input data may be obtained by the second computer system. The input data (i) may describe one or more user inputs into the second computer system and (ii) may be associated with the display data. At step 806, simulated input data may be generated based on the input data. The simulated input data may mimic the one or more user inputs into the second computer system. Finally, at step 808, the simulated input data may be provided to the application executing on the first computer system. Providing the simulated input data to the application may cause the application to adjust the display data representing at least a portion of the GUI associated with the application in order to provide adjusted display data.

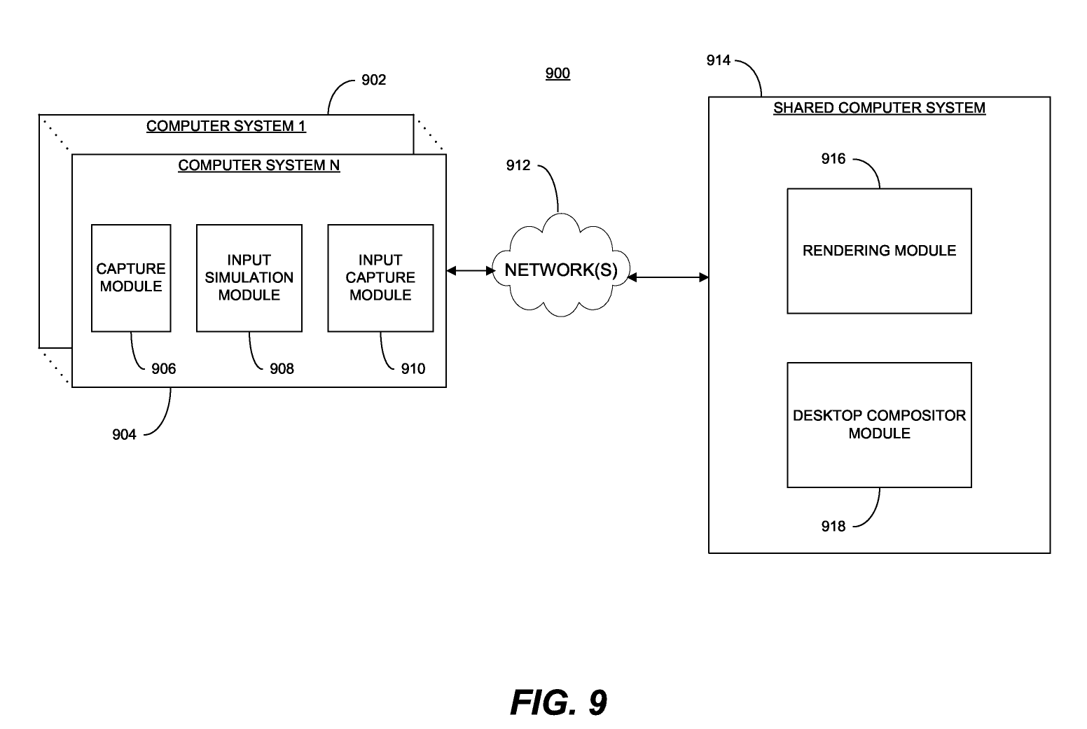

Referring now to FIG. 9, another embodiment of a networked system 900 for sharing one or more graphical user interfaces (GUIs) between a plurality of computer systems in accordance with one or more exemplary embodiments of the present invention is provided. System 900 includes one or more computer systems 902-904 operatively connected to a shared computer system 914 over one or more networks 912. In this embodiment, each computer system 902-904 includes a capture module 906, an input simulation module 908, and an input capture module 910. These modules 906-910 function substantially in line with the discussion of modules 716, 724, and 734 discussed above with regard to FIG. 7. Shared computer system 914 may include a rendering module 914 that functions substantially in line with rendering modules 722 and 732 discussed above with regard to FIG. 7.

System 900 operates similar to system 700 discussed above, however, in this embodiment, any display data (or adjusted display data) is rendered on the shared computer system 914, rather than on any individual computer system, e.g., computer systems 902-904. In one example, the shared computer 914 may be a server computer or the like providing “cloud computing” functionality to the networked computer systems 902-904. Thus, in this embodiment, users of the computer systems 902-904 could select GUIs (or portions of GUIs) to share. The display data representing these GUIs (or portions of GUIs) would then be uploaded to the shared computer system 914. The rendering module 916 of the shared computer may be configured to render the display data received from the computer systems 902-904. The desktop compositor module may then be configured to combine all of the rendered GUIs (or portions of the GUIs) together into a single “desktop.” Display data representing the desktop may then be transmitted back to one or more of the computer systems 902-904 via the network(s) 912 for output on the display devices of the computer systems 902-904. As with system 700 discussed above, any user inputs into the computer systems 902-904 aimed at interacting with the desktop may be transmitted via the network(s) back to the shared computer system to update the display data representing the desktop, such that display data representing an adjusted desktop may then be supplied back to computer systems 902-904 in line with the techniques discussed above with regard to FIG. 7.

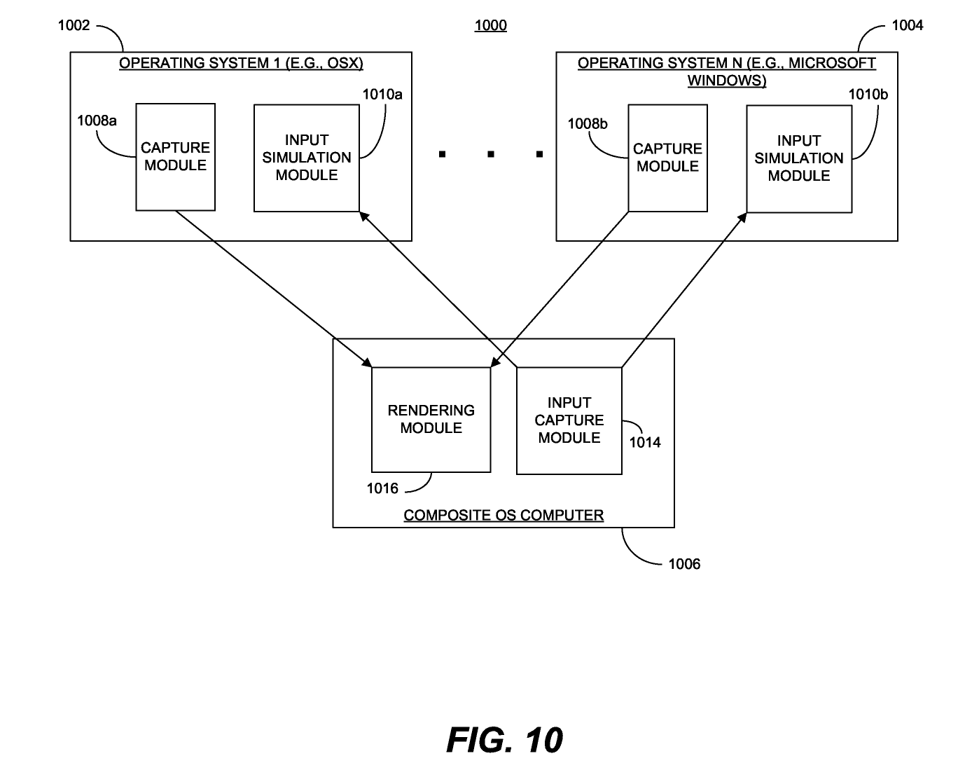

FIG. 10 is a block diagram illustrating a system 1000 for sharing a plurality of GUIs from a plurality of different operating systems in accordance with one or more exemplary embodiments of the present invention. System 1000 includes one or more operating systems 1002-1004 and a composite operating system (OS) computer 1006. In one example, operating system 1 1002 though operating system N 1004 may be executing on the same computer. For example, some computers are capable of running a plurality of operating systems simultaneously, however, in conventional systems, the GUIs of those operating systems are either split across the display device of the computer (e.g., segmented with a first operating system GUI in a left pane and a second operating system GUI in a right pane), or only a single operating system GUI is displayed. In another embodiment, operating system 1 1002 may be executing on a first computer system while operating system 1004 is executing on a second, different computer system. Nonetheless, the instant teachings apply equally to either scenario. Stated differently, operating system 1 1002 and/or operating system 1004 may each be either real or virtual machines.

Operating system 1 1002 includes a capture module 1008a and an input simulation module 1010a. Operating system N 1004 also includes a capture module 1008b and an input simulation module 1010b. The capture modules 1008a, 1008b and the input simulation modules 1010a, 1010b are configured to operate substantially in accordance with the discussion of those components set forth with regard to FIG. 7 above.

The composite OS computer 1006 includes a rendering module 1016 and an input capture module 1014. In some embodiments, operating system 1 1002 and operating system N 1004 may be executing on the composite OS computer 1006. In other embodiments, the composite OS computer 1006 may be a different physical computer system than the one or more computer systems executing operating systems 1002-1004. In such an embodiment, the computer systems executing operating systems 1002-1004 may be operatively connected to the composite OS computer 1006 via one or more wired or wireless networks in order to transfer the data contemplated herein.

In the embodiment illustrated in FIG. 10, display data representing at least a portion of a GUI associated with operating system 1 1002 and display data representing at least a portion of a GUI associated with operating system 2 1004 may be captured by capture modules 1008a, 1008b. In line with the teachings above, the input capture module 1014 of the composite OS computer may combine (i) the display data representing at least a portion of a GUI associated with operating system 1 1002 and (ii) the display data representing at least a portion of a GUI associated with operating system 2 1004 into a composite “desktop.” The composite desktop may be rendered by the rendering module 1016 of the composite computer system and the rendered display data may be transmitted back to operating system 1 1002 and/or operating system 2 1004. The input capture module 1014 of the composite OS computer may function in a substantially similar way to the input capture module 734 discussed above with regard to FIG. 7. Applying the foregoing techniques, a user of system 1000 may interact with the composite OS computer 1006 to view and manipulate GUIs (or portions of GUIs) associated with applications running on different operating systems.

The various embodiments of the present invention can be computer implemented. For example, various embodiments of the present invention comprise memory with executable instructions stored thereon. The instructions can be executed by one or more processors to carry out the various aspects of the present invention discussed above.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. Instead, it is intended that the invention is defined by the claims appended hereto.

What is claimed is:

1. A computer-implemented method for sharing one or more graphical user interfaces (GUIs) between a plurality of computer systems, the method comprising:
obtaining, by a first computer system, display data representing at least a portion of a GUI associated with an application executing on the first computer system;
transmitting, by the first computer system, the display data to a second computer system;
obtaining, by the first computer system from the second computer system, input data describing one or more user inputs into the second computer system associated with the display data;
generating, by the first computer system, simulated input data based on the input data, wherein the simulated input data mimics the one or more user inputs into the second computer system; and
providing, by the first computer system, the simulated input data to the application executing on the first computer system, wherein providing the simulated input data to the application causes the application to adjust the display data representing at least a portion of the GUI associated with the application in order to provide adjusted display data.

2. The computer implemented method of claim 1, further comprising:
obtaining, by the first computer system, the adjusted display data; and
transmitting, by the first computer system, the adjusted display data to the second computer system.

3. The computer-implemented method of claim 2, further comprising:
obtaining, by the first computer system from the second computer system, different input data describing one or more different user inputs into the second computer system associated with the adjusted display data;
generating, by the first computer system, different simulated input data based on the different input data, wherein the different simulated input data mimics the one or more different user inputs into the second computer system; and
providing, by the first computer system, the different simulated input data to the application executing on the first computer system, wherein providing the different simulated input data to the application causes the application to further adjust the adjusted display data representing at least a portion of the GUI associated with the application in order to provide further adjusted display data.

4. The computer-implemented method of claim 1, further comprising:
obtaining, by the first computer system, share instruction data, wherein the share instruction data comprises an instruction to share, with the second computer system, at least a portion of the GUI associated with the application.

5. The computer-implemented method of claim 4, wherein obtaining the share instruction data comprises obtaining an indication that a user of the first computer system has dragged at least a portion of the GUI off of an edge of a display device of the first computer system.

6. The computer-implemented method of claim 1, further comprising:
rendering, by the first computer system, the display data prior to transmitting the display data to the second computer system.

7. A computer system for sharing one or more graphical user interfaces (GUIs) between a plurality of computer systems, the computer system comprising:
a capture module, wherein the capture module is configured to obtain display data representing at least a portion of a GUI associated with an application executing on the computer system;
a transceiver operatively connected to the capture module, wherein the transceiver is configured to:
transmit the display data to a second computer system; and
obtain, from the second computer system, input data describing one or more user inputs into the second computer system associated with the display data;
an input simulation module operatively connected to the transceiver, wherein the input simulation module is configured to:
generate simulated input data based on the input data obtained from the second computer device, wherein the simulated input data mimics the one or more user inputs into the second computer system; and
provide the simulated input data to the application executing on the computer system, wherein providing the simulated input data to the application causes the application to adjust the display data representing at least a portion of the GUI associated with the application in order to provide adjusted display data.

8. The computer system of claim 7, wherein:
the capture module is further configured to obtain the adjusted display data; and
the transceiver is further configured to transmit the adjusted display data to the second computer system.

9. The computer system of claim 8, wherein:
the transceiver is further configured to obtain, from the second computer system, different input data describing one or more different user inputs into the second computer system associated with the adjusted display data; and
the input simulation module is further configured to:
generate different simulated input data based on the different input data, wherein the different simulated input data mimics the one or more different user inputs into the second computer system; and
provide the different simulated input data to the application executing on the computer system, wherein providing the different simulated input data to the application causes the application to further adjust the adjusted display data representing at least a portion of the GUI associated with the application in order to provide further adjusted display data.

10. The computer system of claim 7, further comprising:
a user input module configured to obtain share instruction data, wherein the share instruction data comprises an instruction to share, with the second computer system, at least a portion of the GUI associated with the application.

11. The computer system of claim 10, wherein the computer system further comprises a display device, and wherein the user input module is configured to obtain the share instruction data by obtaining an indication that a user of the computer system has dragged at least a portion of the GUI off of an edge of the display device.

12. The computer system of claim 7, further comprising:
a rendering module operatively connected to the capture module and the transceiver, wherein the rendering module is configured to render the display data prior to the display data being transmitted to the second computer system.

13. A non-transitory computer-readable medium comprising executable instructions that when executed by one or more processors cause the one or more processors to effectuate a method comprising:
obtaining display data representing at least a portion of a graphical user interface (GUI) associated with an application executing on a first computer system;
transmitting the display data to a second computer system;
obtaining, from the second computer system, input data describing one or more user inputs into the second computer system associated with the display data;
generating simulated input data based on the input data, wherein the simulated input data mimics the one or more user inputs into the second computer system; and
providing the simulated input data to the application executing on the first computer system, wherein providing the simulated input data to the application causes the application to adjust the display data representing at least a portion of the GUI associated with the application in order to provide adjusted display data.

14. The computer-readable medium of claim 13, wherein the executable instructions, when executed by the one or more processors, cause the one or more processors to effectuate the method further comprising:
obtaining the adjusted display data; and
transmitting the adjusted display data to the second computer system.

15. The computer-readable medium of claim 14, wherein the executable instructions, when executed by the one or more processors, cause the one or more processors to effectuate the method further comprising:
obtaining, from the second computer system, different input data describing one or more different user inputs into the second computer system associated with the adjusted display data;
generating different simulated input data based on the different input data, wherein the different simulated input data mimics the one or more different user inputs into the second computer system; and
providing the different simulated input data to the application executing on the first computer system, wherein providing the different simulated input data to the application causes the application to further adjust the adjusted display data representing at least a portion of the GUI associated with the application in order to provide further adjusted display data.

16. The computer-readable medium of claim 13, wherein the executable instructions, when executed by the one or more processors, cause the one or more processors to effectuate the method further comprising:
obtaining share instruction data, wherein the share instruction data comprises an instruction to share, with the second computer system, at least a portion of the GUI associated with the application.

17. The computer-readable medium of claim 16, wherein obtaining the share instruction data comprises obtaining an indication that a user of the first computer system has dragged at least a portion of the GUI off of an edge of a display device of the first computer system.

18. The computer-readable medium of claim 13, wherein the executable instructions, when executed by the one or more processors, cause the one or more processors to effectuate the method further comprising:
rendering the display data prior to transmitting the display data to the second computer system.
